(19) United States
(12) Patent Application Publication
(10) Pub. No.: US 2001/0047626 A1
(43) Pub. Date: Dec. 6, 2001

(54) Window controlling method

(76) Inventor: Akira Ohkado, Yokohama-shi (JP)

Correspondence Address: Ronald L. Drumheller, Esq., 94 Teakettle Spout Road, Mahopac, NY, 10541, US

(21) Appl. No.: 09/771,325

(22) Filed: Jan. 26, 2001

(30) Foreign Application Priority Data
Jan. 26, 2000 (JP) 2000-016548

(51) Int. Cl. E06B 3/00

(52) U.S. Cl. 49/506

(57) ABSTRACT

A window controlling method makes a chat window immediately available without being an obstacle, when a user wants to use it. The window is enlarged to a first size larger than the window size used in activating an application program when the volume of the contents to be displayed on the window reaches a predetermined value, and the window is reduced to a second size smaller than the first size when at least a part of the contents to be displayed on the window is erased.

### BACKGROUND OF THE INVENTION

1. Field of the Invention

The present invention relates to a method of controlling a window of an application program in a window system on computers, more particularly to a method of controlling a window of a chat program.

2. Related Art

A text chat is a function usually used in a collaboration and the like. Microsoft Netmeeting 2.1 is typical of a text chat.

In a collaboration, a person on the other end of a communication line, conditions for communication and the like are usually managed by a window different from a chat window, since they are common to a plurality of functions including a chat. For a typical chat window used in this manner, at least three elements, that is, a user-input area, a transmission button and a chat history are indispensable and a clear button for erasing a history in case of change of a subject is usually provided.

It is usual that the size of a chat window is usually fixed and is resized according to a user's needs, but there is a possibility that the chat window becomes an obstacle to operation of the other applications. However, when the chat window is minimized or the chat window is under the other windows, operations necessary for performing a chat, such as restoring to an original size, displaying a task bar and moving a window, degrade operability.

A method of displaying a message area of only one line on a title bar is inconvenient for operation, since a chat history, which is composed of a message from a person on the other end of the communication line and a message from oneself, is needed in many cases. A displaying method, in which the size of an instruction window is enlarged in the case of a need of a supporting message, is disclosed in Japanese Patent Laid-Open No. 6-348440, but the method is unsuitable for the chat program and the like, since an operation such as depressing a button is needed and the volume of an supporting message is predetermined. A method of displaying a message except a title on the title bar of a window is disclosed in Japanese Patent Laid-Open No. 9-146752, but the method is also unsuitable for the chat program, since an operation such as scrolling is needed as message volume increases.

### SUMMARY OF THE INVENTION

The object of the present invention is to provide a window controlling method for displaying a chat window which is immediately available, without being an obstacle, when a user wants to use the chat window.

One embodiment of the window controlling method according to the present invention comprises the steps of:

enlarging the window to a first size larger than the window size used in activating the application program when the volume of the contents to be displayed on the window reaches the predetermined value; and

reducing the window to a second size smaller than the first size when at least a part of the contents to be displayed on the window is erased.

Another embodiment of the window controlling method according to the present invention comprises the steps of:

enlarging the window to the first size larger than a window size used in starting the application program according to increase of volume of the contents to be displayed on the window; and

reducing the window to the second size smaller than the first size when at least a part of the contents to be displayed on the window is erased.

As described above, according to the present invention, the size of a window is changed according to the condition of the application program without being clearly specified by a user. Especially, in a standby state, setting a window to the minimum size available for use (hereinafter referred to as a minimum state) makes it possible for the window to be used immediately, without being an obstacle for the other applications, when a user wants to use the window. In an auxiliary use of the chat window such as confirmation or transmitting the name of a place and the like which is difficult to be conveyed in voice, erasing the contents of a window when one of the two users does not need the contents may make the application program set in a standby state.

The present invention is particularly effective when it is applied to a window of the chat program, and more particularly effective when a plurality of application windows are always open as in an agent of a call center.

Even when a window is not in a minimum state, setting the window to the minimum size necessary for the contents to be displayed enables the other applications to be visually confirmed during use of the chat window. In still another embodiment of the window controlling method according to the present invention, a window of the chat program in a normal state may be provided with a message input area, a transmission button, a history display area and a clear button, and a window of the chat program in a minimum state may be provided with only the message input area and the transmission button.

When used in a collaboration and the like, it is advantageous that the chat window is not under windows of the other applications. Consequently, yet another embodiment of the window controlling method according to the present invention has a feature in that a window of the application program is always displayed adjacent to a window of another predetermined application program. Still further embodiment of the window controlling method according to the present invention has a feature in that a window of the application program is always displayed adjacent to a window of another predetermined application program only when a window of the application program is the first size.

### BRIEF DESCRIPTION OF THE DRAWINGS

For a more complete understanding of the present invention and the advantages thereof, reference is now made to the following description taken in conjunction with the accompanying drawings.

FIG. 1 is a block diagram of the chat system executing the window controlling method according to the present invention.

FIG. 2 is a view showing one example of the chat window.

FIG. 3 is a view showing one example of the chat window in a minimum state.

FIG. 4 is a block diagram showing the general constitution in performing a collaboration.

FIG. 5 is a view showing one example of the operation panel of the customer side.

FIG. 6 is a view showing one example of the panel for inputting customer information.

FIG. 7 is a flowchart for explaining the controlling operation of the window size of the chat system 1.

FIG. 8 is a flowchart for explaining the controlling operation of the window position of the chat system 1.

### DETAILED DESCRIPTION OF THE PREFERRED EMBODIMENTS

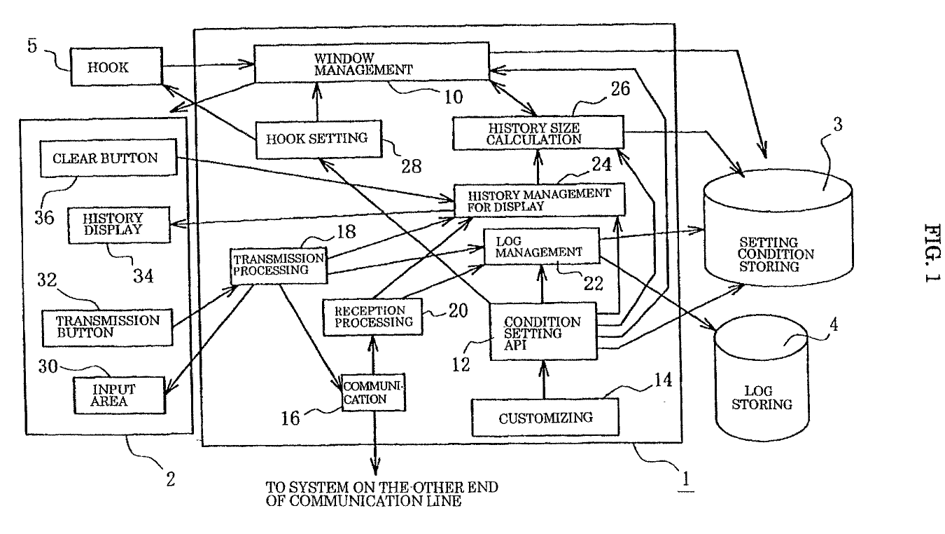

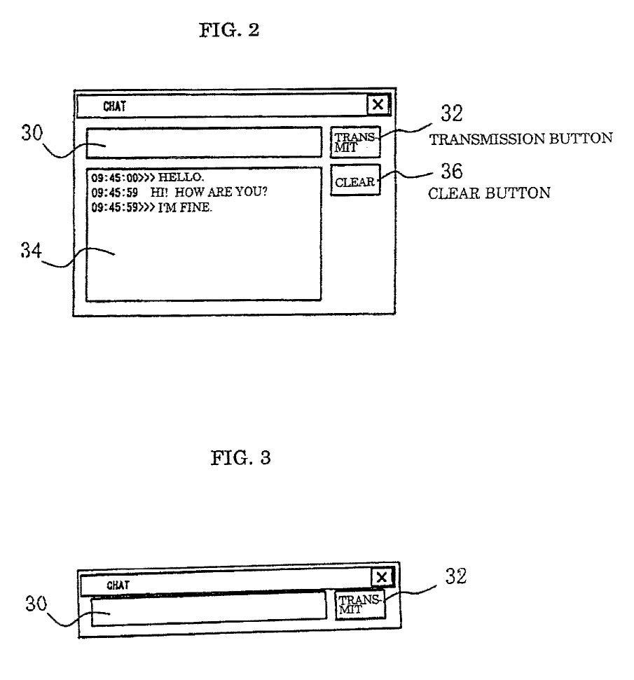

An example where the present invention is applied to a chat system will be described below with reference to the drawings. FIG. 1 is a block diagram of the chat system executing the window controlling method according to the present invention. A chat system 1 comprises a window management section 10, a condition setting API section 12, a customizing section 14, a communication section 16, a transmission processing section 18, a reception processing section 20, a log management section 22, a history management section for display 24, a history size calculation section 26 and a hook setting section 28. A chat window 2 controlled by the chat system 1 comprises an input area 30 into which a user inputs a message, a transmission button 32 for transmitting a message inputted into the input area 30, a history displaying portion 34 for displaying a history of a chat and a clear button 36 for erasing a history displayed in the history displaying portion 34. FIG. 2 shows one example of such chat windows. As shown in FIG. 3, the chat window in a minimum state where there is no history to be displayed comprises only the input area 30 and the transmission button 32.

In FIG. 1, after the chat system 1 is activated, firstly the window management section 10 refers to setting conditions, which are stored in the setting condition storing section 3, such as whether or not a title bar is displayed or whether or not a transmission button is displayed, and the height of a title bar defined in a system environment. Secondly, the window management section 10 refers to the size of a font, such as a system font, to be used. And thirdly, the window management section 10 calculates the size of the chat window in a minimum state and sets the size of a window to the calculated size. This calculated size is defined as the minimum size necessary to display the contents of a chat. Table 1 shows an example of the setting conditions of the window.

TABLE 1

| | |
|---|---|
| Title bar in minimum state*1 | yes |
| Transmission button state*1 | yes |
| Present window state | minimum |
| Window position and size | (10,320)-(20,200) |
| Minimum window size | (20,200) |
| Window height margin | 40 |
| Position in minimum state*1 | (10,320) |
| Width in normal state*1 | 300 |
| Window position *1 | under object window |
| Window follow*1 | minimum state only |
| Object window handle*2 | 80012345 |
| Object window position and size | (10,320)-(500,500) |
| Minimum state setting*1 | yes |

In Table 1, to data shown as “*1”, a default value is specified by the contents of the chat program. Data shown as “*2” is given via an API section 12 in executing a chat program. Data other than the above-mentioned data is calculated and changed at the time of activating or during executing the program. It is not indispensable but desirable that the data shown as “*1” can be changed via the API section 12 through the customizing section 14. Additionally, it is preferable that GUI for changing data is provided to improve easiness of operation according to a user's preference. In the case of changing the data by GUI, it is necessary to memorize the setting conditions thereof.

As window following conditions for an object window of the other application, conditions such as “A position is fixed in a minimum state”, “Follows only in the case of a minimum state”, “Always follow”, “Do not follow” can be set. A position of the window is used only in the case where the window follows an object window, and “On an object window”, “Under an object window”, “On a title bar of an object window” can be set. Although “On the right (or left) side of an object window” is also possible technically, it is not usually used because it does not meet the requirement of displaying the window in a small area. The following of the window is not indispensable in an embodiment of the present invention.

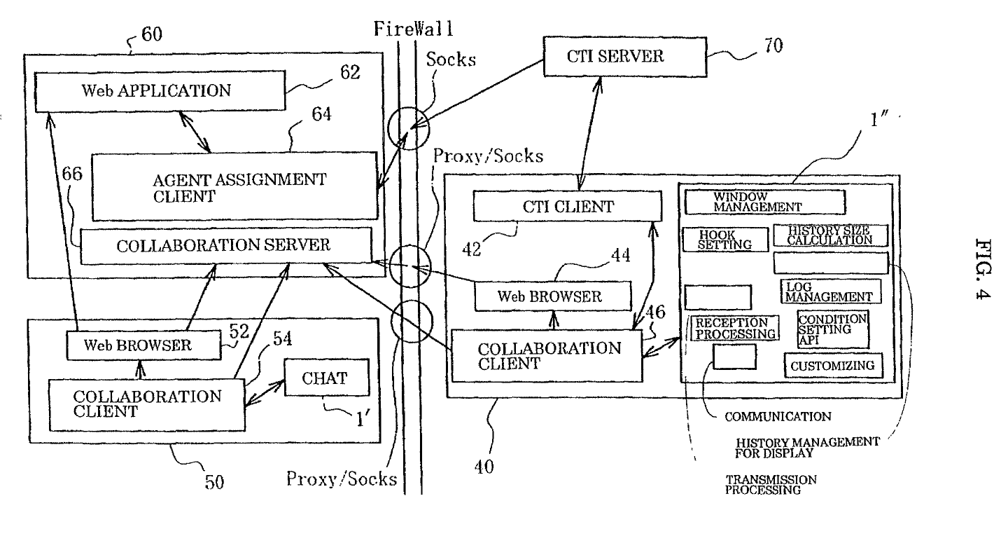

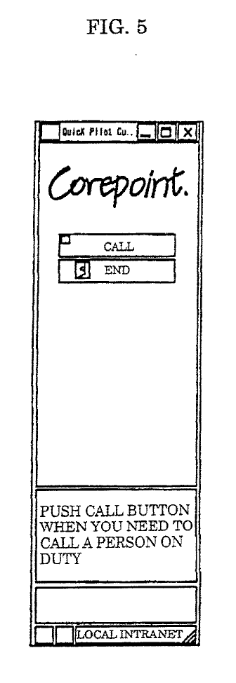

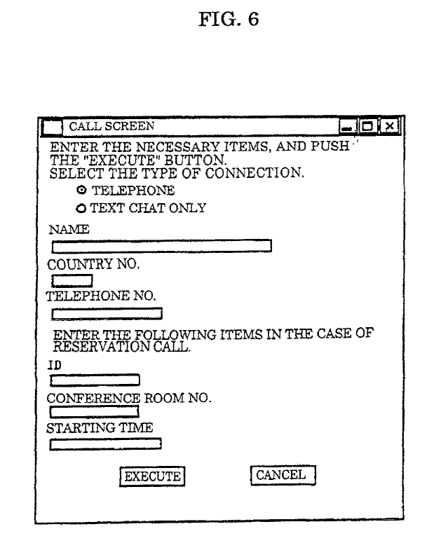

FIG. 4 is a block diagram showing a general constitution in executing a collaboration. In starting the collaboration, an agent logs on from a CTI client 42 of an agent side system 40 to initiate an operation. This makes the agent available. When a customer wants to call the agent while accessing a Web server 60 by a Web browser 52 of a customer side system 50, the customer pushes a call button on an operation panel of a customer side as shown in FIG. 5. Then, a customer information input panel as shown in FIG. 6 is displayed. By pushing an execution button, after a name and a telephone number are inputted, data is sent to a Web application 62 in the Web server 60. The Web application 62 calls an agent assignment client 64 in the same server and requests a CTI server 70 for an assignment of an agent. The CTI server 70 selects an agent presently not in communication, and conducts an assignment and notifies a receipt of a message to the agent side system 40. At this time, an indication telling that the receipt of the message is not a telephone call is preferably displayed. After the assignment of the agent, the assignment information is sent back to a client via the agent assignment client 64, and a collaboration client 54 begins communication with a collaboration server 66. On the other hand, the collaboration client 46 in an agent side which received the information about the assignment of the agent from the CTI client 42 also begins communication with the collaboration server 66. After establishment of the communication, the collaboration clients 46 and 54 in both sides respectively instruct chat systems 1′ and 1″, similar to the chat system 1 as shown in FIG. 1, to start communication. For example, in aligning with the Web browsers 44 and 52, the collaboration clients 46 and 54 request a movement of a window position together with data, such as a window handle, which specifies toolbar windows of the collaboration clients 46 and 54. Chat system 1′ and 1″ set hooks for object windows. In this example, a collaboration by Web browsers by using Corepoint Web Collaboration has been described. But the present invention can be applied to any collaboration having a possibility of using a chat. As for a transmission protocol, TCP/IP is usually used, but any protocol capable of establishing a communication session is available. Additionally, it is usual that communication routes are provided for the whole of a collaboration and shared, but communication routes may be provided only for a chat. A firewall shown in FIG. 4 is usually used to increase safety of a system, but it is not an essential requirement for the present invention.

In FIG. 1, in order to transmit a message, a user inputs message into the input area 30 of the chat window 2 and pushes the transmission button 32. Consequently, a processing for message transmission is activated. The transmission processing section 18 receives the message in the input area 30, adds a user ID, a time for transmission and the like according to needs of a collaboration system and creates a text to be transmitted. After the transmission processing section 18 sent the created message to the log management section 22 and the history management section for display 24, the transmission processing section 18 sends the message to a system on the other end of the communication line via the communication section 16. The log management section 22 stores the message in a log storing section 4. A log is used according to needs for a record, but it is not an essential function. Systems on the other end of the communication line may be either single or plural. In the case of a plurality of systems, broadcasting is also available by using a system with a broadcasting function such as a conference room management server. After sending the message, the history management section for display 24 adds the message to a display history.

After establishment of the communication, the chat system 1 receives the message sent from the system on the other end of the communication line in the transmission section 16, and sends the message to the reception processing section 20. The reception processing section 20 adds an arrival time, a string indicating a receipt of the message according to needs of a collaboration system, and creates a text for display. The reception processing section 20 sends the created message to the log management section 22 and the history management section for display 24. The log management section 22 stores the message in the log storing section 4. A log is used according to needs for a record, but it is not an essential function. The history management section for display 24 adds the message to the display history.

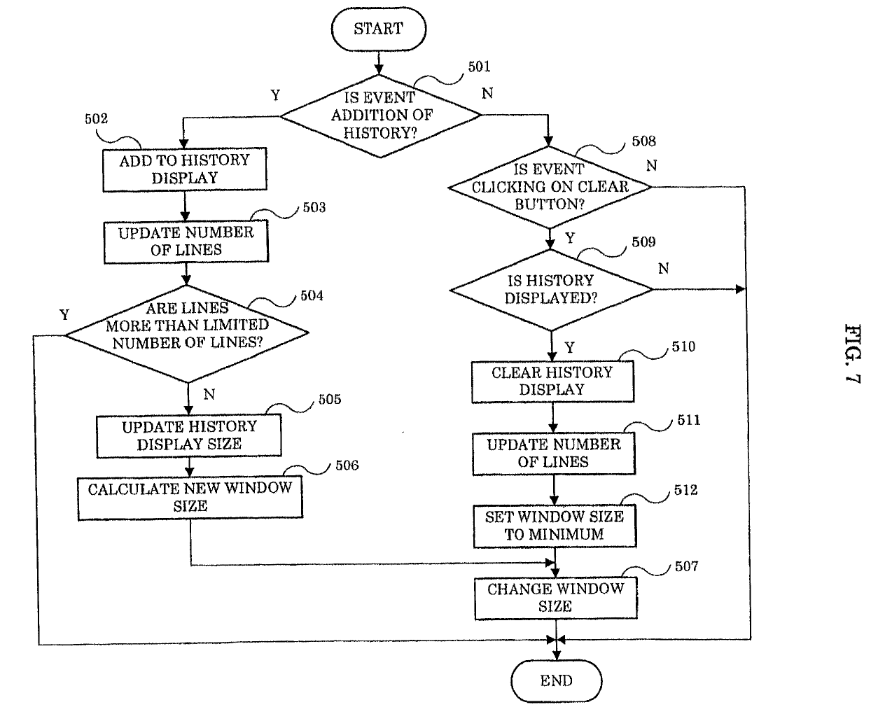

FIG. 7 is a flowchart for explaining a controlling operation for a window size of the chat system 1. If an event in step 501 is an addition of a history for display, a message is added in step 502 to a GUI component for displaying a history, which constitutes GUI. In step 503, a history size calculation part 26 calculates the number of lines after addition of the message, based on the length of the message and the kind of the GUI component, to determine whether the number of lines to be added are two or more. In step 504, if the number of lines exceeds the limited number of lines, the window size is not updated, and the operation is completed. If the number of lines is the limited number of lines or less, the size of a history display area 34 is calculated according to the number of lines in step 505, and sent to the window management section 10. In step 506, the window management section 10 calculates the window size based on the size of the history display area 34 and the size of the other fixed portion. The size of the window is changed in step 507, and the operation is completed. When the present state is a minimum state, the width of the window is also changed.

When a user does not wish to change the window size continuously, or when the calculation of the size of the window according to the number of lines is impossible because of restriction by an operating system, the window may be managed in such a manner that it uses only two states, that is, a minimum state and a normal state, and addition of even one line leads to the normal state and the normal state is maintained until restoring to the minimum state.

If an event is to click on the clear button 36 in step 501 and if a history is presently displayed in step 508, all the messages displayed by the GUI component for history display are erased in step 510. This erasion is notified the history size calculation section 26 of and, in step 511, the number of lines is updated to zero in the history size calculation section 26. In step 512, the history size calculation section 26 notifies the window management section 10 of moving to a minimum state. The window management section 10 changes the size of the window in step 507, and the operation is completed. Since the period for keeping a history depends on the respective users on terminal units, it is desirable that the clear function influences only the present system. However, the clear function may link with the system on the other end of the communication line by sending a message instructing the clear function to the terminal unit on the other end of the communication line.

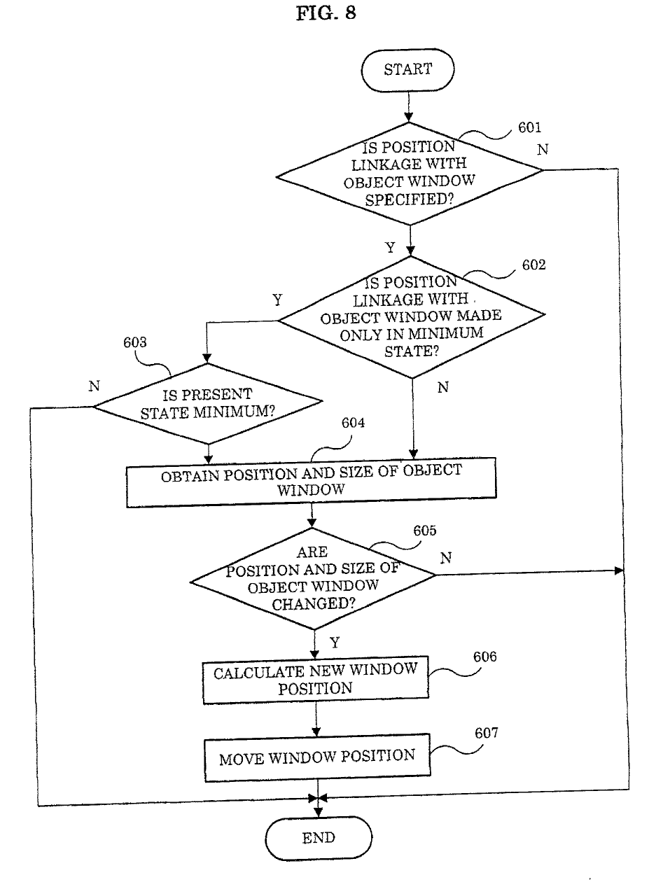

FIG. 8 is a flowchart for explaining a controlling operation of a window position of the chat system 1. The window management section 10 sets a window size to the size in a minimum state determined by calculation in activation and changes the window size. When the follow condition is “A position is fixed in a minimum state”, a position is also changed.

In the case of alignment with an object window, an external program requires linkage of a position together with data, such as a window handle, specifying an object window in the chat system 1 via API, and sets the hook 5 for the object window in the hook setting section 28 of the chat system 1.

When the object window is moved or the size of the object window is changed, a related event thereto is detected in the hook 5, and the window management section 10 is notified of the event.

In step 601, the window management section 2 checks up whether linkage with the object window is specified. If specified, it checks up whether linkage is conducted only in a minimum state in step 602. If conducted only in a minimum state, it checks up whether the present state is a minimum state in step 603. If the present state is not a minimum state, the processing is completed.

In the case of linkage, the position and the size of the object window are obtained in step 604, and the window management section 2 checks up whether the position and the size are changed in step 605. If they are changed, a new window position is calculated according to relative relationship with the object window such as “On”, “Under”, “On a title bar” in step 606, and the window is moved to the new position in step 607. Additionally, a Z-order of the chat window 20 is also changed according to the Z-order of the object window.

As described above, the present invention provides a window controlling method, for example, for displaying a chat window immediately available without being an obstacle, when a user wants to use it.

Although the preferred embodiments of the present invention have been described in detail, it should be understood that various changes, substitutions and alternations can be made therein without departing from spirit and scope of the inventions as defined by the appended claims.

What is claimed is:

1. A window controlling method for an application program of a computer window system, comprising the steps of:
enlarging said window to a first size larger than the window size used in activating the application program when the volume of the contents to be displayed on said window reaches the predetermined value; and
reducing said window to a second size smaller than the first size when at least a part of the contents to be displayed on said window is erased.

2. The window controlling method according to claim 1, wherein said application program is a chat program.

3. The window controlling method according to claim 2, wherein a window used in activating the application program and a window of the second size include a message input area and a transmission button, and a window of the other size includes a message input area, a transmission button, a history display area and a clear button.

4. The window controlling method according to claim 1, wherein a window of said application program is always displayed adjacent to a window of the other predetermined application program.

5. The window controlling method according to claim 1, wherein a window of said application program is always displayed adjacent to a window of the other predetermined application program only when the window size of said application program is the first size.

6. A window controlling method for an application program of a computer window system, comprising the steps of:
enlarging said window to a first size larger than the window size used in activating the application program according to increase of the volume of the contents to be displayed on said window; and
reducing said window to a second size smaller than the first size when at least a part of the contents to be displayed on said window is erased.

7. The window controlling method according to claim 6, wherein said application program is a chat program.

8. The window controlling method according to claim 7, wherein a window used in activating the application program and a window of the second size include a message input area and a transmission button, and a window of the other size includes a message input area, a transmission button, a history display area and a clear button.

9. The window controlling method according to claim 6, wherein a window of said application program is always displayed adjacent to a window of the other predetermined application program.

10. The window controlling method according to claim 6, wherein a window of said application program is always displayed adjacent to a window of the other predetermined application program only when the window size of said application program is the first size.
